(19) United States
(12) Patent Application Publication
(10) Pub. No.: US 2016/0300372 A1
(43) Pub. Date: Oct. 13, 2016

(54) System and Method for Graphically Indicating an Object in an Image

(71) Applicant: Bendix Commercial Vehicle Systems LLC, Elyria, OH (US)

(72) Inventors: Hans M. Molin, Mission Viejo, CA (US); Andreas U Kuehnle, Villa Park, CA (US); Cathy L. Boon, Orange, CA (US); Marton Gyori, Budapest (HU)

(73) Assignee: Bendix Commercial Vehicle Systems LLC, Elyria, OH (US)

(21) Appl. No.: 14/682,604

(22) Filed: Apr. 9, 2015

(51) Int. Cl. G06T 11/60; G06K 9/62; G06T 7/60; G06K 9/46

(52) U.S. Cl. CPC G06T 11/60; G06K 9/46; G06K 9/6215; G06T 7/60; G06K 2009/4666; G06T 2207/30252; G06T 2207/20212

(57) ABSTRACT

A method for graphically indicating an object in a final image includes obtaining a plurality of sub-images including the object from respective image capturing devices at different angles, replacing a portion of a first of the sub-images with a corresponding portion of a second of the sub-images, replacing a portion of the second sub-image with a corresponding portion of the first sub-image, and generating the final image including a graphical representation of the object as a two-dimensional view not aligned with a common virtual viewpoint based on the first and second sub-images including the respective replaced portions.

### BACKGROUND

The present invention relates to combining multiple images taken of an object from different angles. It finds particular application in conjunction with a bird's eye view system for a vehicle and will be described with particular reference thereto. It will be appreciated, however, that the invention is also amenable to other applications.

A display image of a bird's eye view system typically combines multiple (e.g., four (4) or more) camera sub-images into a single final image. In areas where the sub-images meet, some sort of stitching or blending is used to make the multiple sub-images appear as a single, cohesive final image. One issue with conventional stitching methods is that three-dimensional objects in combined areas are commonly not shown (e.g., the three-dimensional objects “disappear”) due to the geometric characteristics of the different sub-images. For example, only a lowest part (e.g., the shoes of a pedestrian) may be visible in the stitched area.

One process used to address the issue with 3D objects in combined sub-images is to make the blending of the sub-images more additive. However, one undesirable effect of additive blending is the appearance of duplicate ghost-like figures of objects in a final image, as the object is seen and displayed twice. Such ghosting makes it difficult for a user to clearly perceive the location of the object.

The present invention provides a new and improved apparatus and method for processing images taken of an object from cameras at different angles.

### SUMMARY

In one aspect of the present invention, a method for graphically indicating an object in a final image includes obtaining a plurality of sub-images including the object from respective image capturing devices at different angles, replacing a portion of a first of the sub-images with a corresponding portion of a second of the sub-images, replacing a portion of the second sub-image with a corresponding portion of the first sub-image, and generating the final image including a graphical representation of the object as a two-dimensional view not aligned with a common virtual viewpoint based on the first and second sub-images including the respective replaced portions.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates an exemplary overhead view of a vehicle including a plurality of image capturing devices in accordance with one embodiment of an apparatus illustrating principles of the present invention;

FIG. 2 illustrates a schematic representation of a system for displaying images in accordance with one embodiment of an apparatus illustrating principles of the present invention;

FIG. 3 is an exemplary methodology of processing images of an object taken from different angles in accordance with one embodiment illustrating principles of the present invention;

FIG. 4 illustrates a schematic overhead view of a vehicle including a plurality of image capturing devices showing a final image in accordance with one embodiment of an apparatus illustrating principles of the present invention;

FIG. 5 illustrates alternate representations of the object;

FIG. 6 illustrates alternate representations of the object;

FIG. 7 illustrates a schematic view of a vehicle including a plurality of image capturing devices showing heights of an object and a distance of the object from the vehicle in accordance with one embodiment of an apparatus illustrating principles of the present invention; and

FIG. 8 illustrates simple two-dimensional views of a vehicle and objects not aligned with a common virtual viewpoint in accordance with one embodiment of an apparatus illustrating principles of the present invention.

### DETAILED DESCRIPTION OF ILLUSTRATED EMBODIMENT

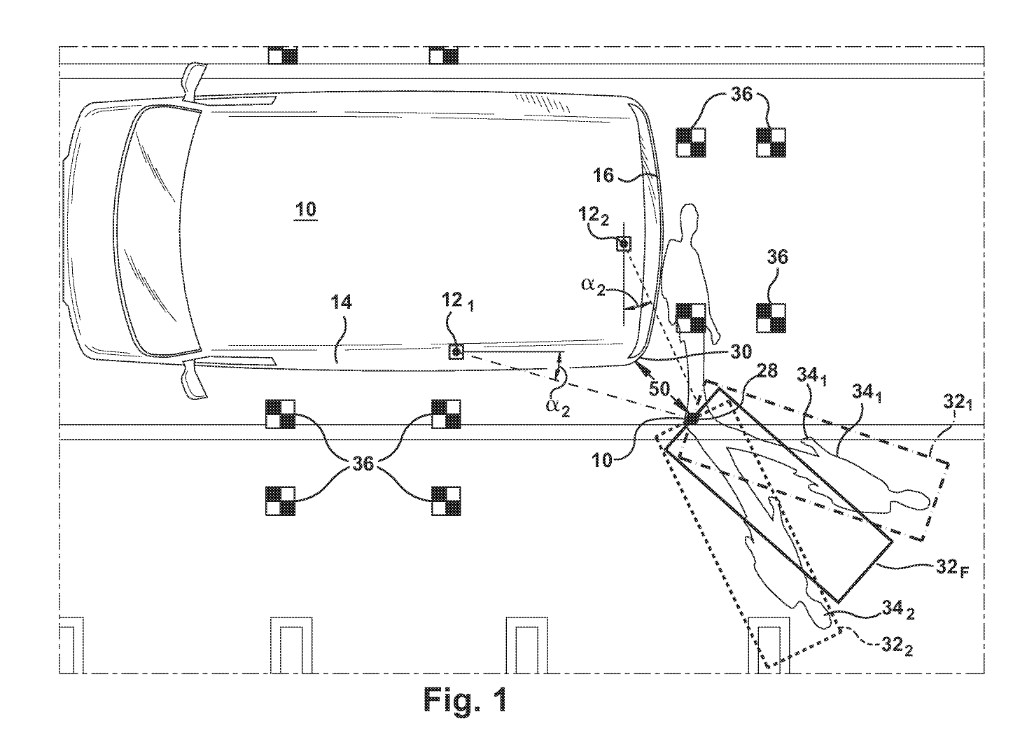

With reference to FIG. 1, a simplified diagram of an exemplary overhead view of a vehicle 10 including a plurality of image capturing devices 12₁, 12₂ is illustrated in accordance with one embodiment of the present invention. In one embodiment, the vehicle 10 is a passenger van and the image capturing devices 12₁, 12₂ are cameras. For ease of illustration, only two (2) cameras 12₁, 12₂ (collectively 12) are illustrated to view a left side 14 and a rear 16 of the vehicle 10. However, it is contemplated that any number of the cameras 12 may be used to provide 360° views around any type of vehicle. Furthermore, other types of passenger vehicles (e.g., passenger automobiles) and heavy vehicles (e.g., busses, straight trucks, and articulated trucks) are also contemplated. Larger vehicles such as busses, straight trucks, and articulated trucks may include more than one camera along a single side of the vehicle. In addition, cameras mounted at corners of the vehicle are also contemplated.

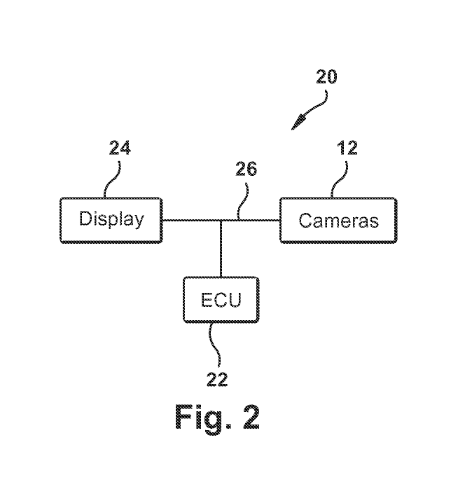

With reference to FIGS. 1 and 2, a system 20 for displaying images includes the cameras 12, an electronic control unit (ECU) 22, a display device 24, and a vehicle communication bus 26 electrically communicating with the cameras 12, the ECU 22, and the display device 24. For example, the ECU 22 transmits individual commands for controlling the respective cameras 12 via the vehicle communication bus 26. Similarly, images from the cameras 12 are transmitted to the ECU 22 via the vehicle communication bus 26. Alternatively, it is contemplated that the cameras 12 communicate with the ECU 22 wirelessly. In one embodiment, it is contemplated that the display device 24 is visible to an operator of the vehicle 10. For example, the display device 24 is inside an operator compartment of the vehicle 10.

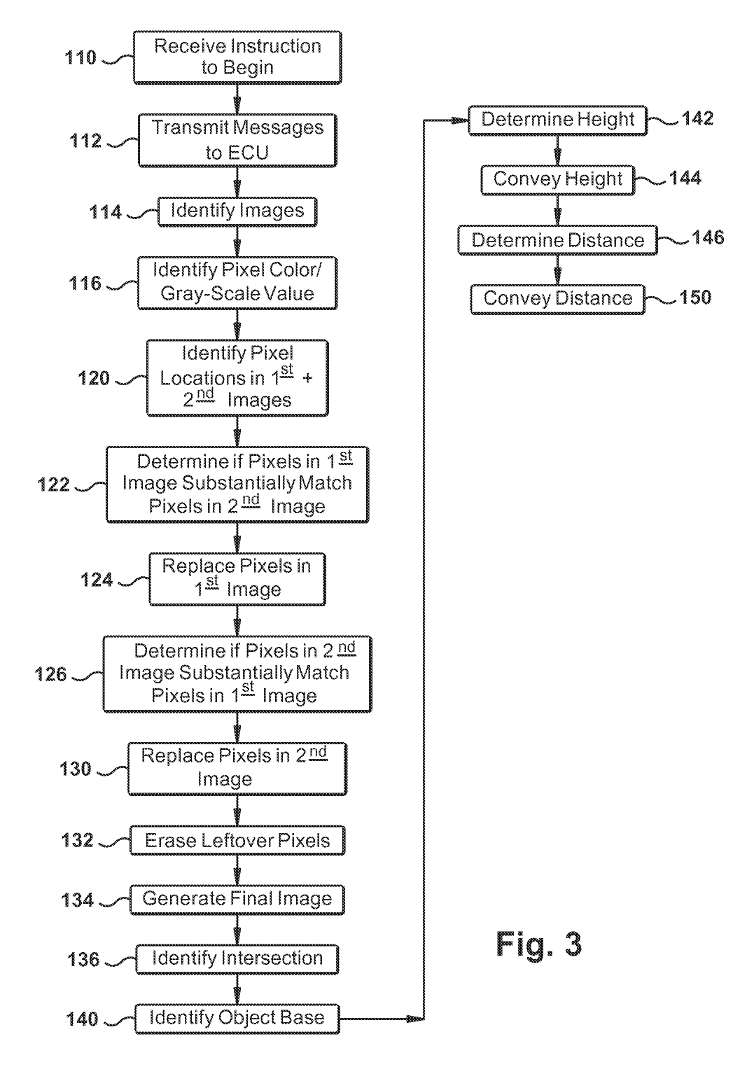

With reference to FIG. 3, an exemplary methodology of the system shown in FIGS. 1 and 2 is illustrated. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1-3, in a step 110, the ECU 22 receives an instruction to begin obtaining preliminary images around the vehicle 10 using the cameras 12. As discussed in more detail below, the preliminary images are used by the ECU 22 to create a single bird's eye view image around the vehicle 10. For simplicity, the steps of processing only an object 28 (e.g., a three-dimensional object) viewed proximate a left, rear corner 30 of the vehicle 10 will be described. However, it is to be understood that similar image processing is performed for other objects viewed at different positions around the vehicle 10. In one embodiment, the ECU 22 receives the instruction to begin obtaining the preliminary images from a switch (not shown) operated by a driver of the vehicle 10. In another embodiment, the ECU 22 receives the instruction to begin obtaining the preliminary images as an initial startup command when the vehicle 10 is first started or when the vehicle is moving slowly enough.

Once the ECU 22 receives an instruction to begin obtaining preliminary images around the vehicle 10, the ECU 22 transmits signals to the cameras 12 to begin obtaining respective preliminary images. For example, the camera 12₁ begins obtaining first preliminary images (“first images”) (see, for example, an image 32₁), and the camera 12₂ begins obtaining second preliminary images (“second images”) (see, for example, 32₂). In the illustrated embodiment, both the first and second images 32_{1,2} include images of the object 28. However, the first images from the first camera 12₁ view the object 28 from a first angle α₁, and the second images from the second camera 12₂ view the object 28 from a second angle α₂. The first image as recorded by the first camera 12₁ is represented as 32₁, and the second image as recorded by the second camera 12₂ is represented as 32₂. The images 32₁, 32₂ are received by and transmitted from the respective cameras 12₁, 12₂ to the ECU 22 in a step 112. In one embodiment, the images 32₁, 32₂ are transmitted from the respective cameras 12₁, 12₂ to the ECU 22 via the vehicle communication bus 26.

In a step 114, the ECU 22 identifies images 32₁ of the object 28 received from the first camera 12₁ as first sub-images and also identifies images 32₂ of the object 28 received from the second camera 12₂ as second sub-images. In one embodiment, each of the first and second images (e.g., sub-images) 32_{1,2}, respectively, includes a plurality of pixels 34. In a step 116, each of the pixels 34 is identified as having a respective particular color value (e.g., each pixel is identified as having a particular red-green-blue (RGB) numerical value) or gray-scale value (e.g. between zero (0) for black and 255 for white) or contrast level (e.g. between −255 and 255 for 8 bit images).

In a step 120, respective locations for each of the pixels 34 in the first and second sub-images 32_{1,2} are identified. In one embodiment, images of in-the-ground plane markers 36, which may be captured by any of the cameras 12, are used by the ECU 22 to map pixel locations around the vehicle 10. The ground plane pixel locations mapped around the vehicle 10 are considered absolute locations and it is assumed that the cameras 12₁, 12₂ are calibrated to measure the same physical location for pixels in the ground plane, causing the cameras to agree on gray level and/or color and/or contrast level values there. Since the ground plane pixel locations mapped around the vehicle are absolute, pixels at a same physical ground plane location around the vehicle 10 are identified by the ECU 22 as having the same location in the step 120 even if the pixels appear in different sub-images obtained by different ones of the cameras 12. For example, since a pixel 34₁ in the first sub-image 32₁ is identified as being at the same physical ground plane location around the vehicle 10 as a pixel 34₂ in the second sub-image 32₂ (i.e., the 34₁ in the first sub-image 32₁ is at a corresponding location with the 34₂ in the second sub-image 32₂), the pixel 34₁ in the first sub-image 32₁ is identified in the step 120 as having the same location (e.g., same absolute ground plane location) as the pixel 34₂ in the second sub-image 32₂.

In a step 122, a determination is made for each of the pixels in the first sub-image 32₁ (i.e., the image from the first camera 12₁) whether the respective pixel substantially matches a color (or gray-scale or contrast) of the pixel at the corresponding location in the second sub-image 32₂ (i.e., the image from the second camera 12₂). In one embodiment, the respective numerical color (or gray-scale) value for each of the pixels in the first sub-image 32₁ is compared with the numerical color (or gray-scale or contrast) value of the pixel at the corresponding location in the second sub-image 32₂. If the numerical color (or gray-scale) value of the respective pixel in the first sub-image 32₁ is within a predetermined threshold range of the numerical color (or gray-scale) value of the respective pixel at the corresponding location in the second sub-image 32₂, it is determined in the step 122 that the respective pixel in the first sub-image 32₁ substantially matches the pixel at the corresponding location in the second sub-image 32₂ (thereby implying or signifying that the pixel seen there belongs to the ground plane). For example, if the first and second sub-images 32_{1,2}, respectively, are color images represented with RGB values, each of the respective R-value, G-value, and B-value of the pixel in the first sub-image 32₁ must be within the predetermined threshold range of the R-value, G-value, and B-value of the corresponding pixel in the second sub-image 32₂. This range can be captured with, for instance, the Euclidean distance between respective RGB values: square root ((R1−R2)*(R1−R2)+(G1−G2)*(G1−G2)+(B1−B2)*(B1−B2)). Other distance measures may be used, including Manhattan, component ratios, etc.

In one embodiment, it is contemplated that each of the predetermined threshold range for each of the respective R-value, G-value, and B-value is 10%. In this case, if each of the respective R-value, G-value, and B-value is a value of zero (0) to 255, the respective R-value, G-value, and B-value of the pixel in the first sub-image 32₁ must be within a range of twenty-six (26) along the zero (0) to 255 scale of the R-value, G-value, and B-value of the corresponding pixel in the second sub-image 32₂ to be considered with the predetermined threshold range. Alternatively, if the first and second sub-images are color images represented with gray-scale values, the gray-scale value of the pixel in the first sub-image 32₁ must be within the predetermined threshold range (e.g., within 10% along a range of zero (0) to 255 gray-scale values) of the gray-scale value of the corresponding pixel in the second sub-image 32₂.

Although the above examples disclose the predetermined threshold range as within 10% along a range of zero (0) to 255, it is to be understood that any other predetermined threshold range is also contemplated. For example, instead of a percentage, the predetermined threshold range may be defined as an absolute number.

In a step 124, any of the pixels in the first sub-image 32₁ (i.e., the image from the first camera 12₁) determined in the step 122 to not match respective pixels at corresponding locations in the second sub-image 32₂ (i.e., the image from the first camera 12₁) are replaced. The replacement value comes from the camera angularly nearer to the image location in question, for instance, the differing pixels in 32₁ are replaced by those from camera 12₂. In one embodiment, replacing a pixel 34 in the first sub-image 32₁ with the respective pixel 34 in the second sub-image 32₂ involves replacing the color value (or gray-scale value) of the pixel 34 in the first sub-image 32₁ with the color value (or gray-scale value) of the pixel 34 in the second sub-image 32₂. The effect of replacing the pixels in the step 124 is to replace a portion of the first sub-image 32₁ with a corresponding portion of the second sub-image 32₂. For example, the portion (e.g., pixels) of the first sub-image 32₁ that are inconsistent with a corresponding portion (e.g., pixels) of the second image 32₂ are replaced. The replacement “erases” the inconsistent views, using the background, such as the road surface, there instead. As both views are erased, the object is effectively removed.

In a step 126, a determination is made for each of the pixels in the second sub-image 32₂ (i.e., the image from the second camera 12₂) whether the respective pixel substantially matches a color (or gray-scale) of the pixel at the corresponding location in the original first sub-image 32₁ (i.e., the image from the first camera 12₁). As discussed above, if the numerical color (or gray-scale) value of the respective pixel in the second sub-image 32₂ is within a predetermined threshold range of the numerical color (or gray-scale) value of the respective pixel at the corresponding location in the first sub-image 32₁, it is determined in the step 126 that the respective pixel in the second sub-image 32₂ substantially matches the pixel at the corresponding location in the first sub-image 32₁. For example, if the second and first sub-images 32_{2,1}, respectively, are color images represented with RGB values, each of the respective R-value, G-value, and B-value of the pixel in the second sub-image 32₂ must be within the predetermined threshold range of the R-value, G-value, and B-value of the corresponding pixel in the first sub-image 32₁. Alternatively, if the second and first sub-images are color images represented with gray-scale values, the gray-scale value of the pixel in the second sub-image 32₂ must be within the predetermined threshold range of the gray-scale value of the corresponding pixel in the first sub-image 32₁.

In a step 130, any of the pixels in the second sub-image 32₂ (i.e., the image from the second camera 12₂) determined in the step 126 to not match respective pixels at corresponding locations in the first sub-image 32₁ (i.e., the image from the first camera 12₁) are replaced, in a manner similar to that previously described. In one embodiment, replacing a pixel 34 in the second sub-image 32₂ with the respective pixel 34 in the first sub-image 32₁ involves replacing the color value (or gray-scale value) of the pixel 34 in the second sub-image 32₂ with the color value (or gray-scale value) of the pixel 34 in the first sub-image 32₁. The effect of replacing the pixels in the step 130 is to replace a portion of the second sub-image 32₂ with a corresponding portion of the first sub-image 32₁. For example, the portion (e.g., pixels) of the second sub-image 32₂ that are inconsistent with a corresponding portion (e.g., pixels) of the first image 32₁ are replaced. In a step 132, leftover single or small groups of pixels are erased by a morphological erosion operation.

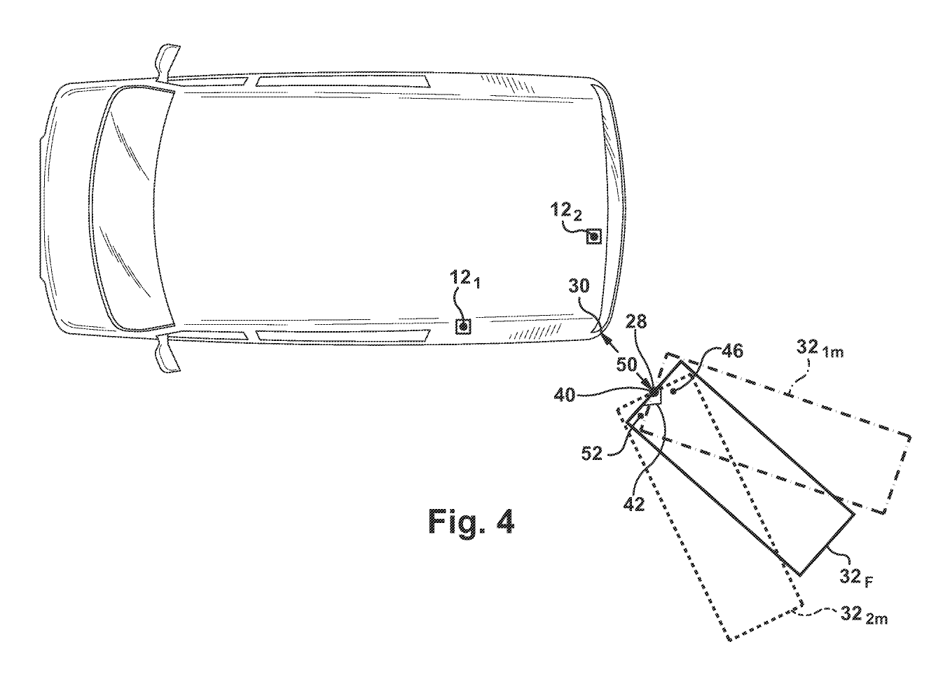

Since the first and second sub-images 32₁, 32₂ of the object 28 are taken from different angles α₁, α₂, respectively, the replacement of pixels in the steps 124 and 130 removes duplicated views (with differing aspects) of the object 28 from the original first and original second sub-images 32₁, 32₂. The first sub-image resulting from the step 124 is referred to as a modified first sub-image 32_{1M} (see FIG. 4). The second sub-image resulting from the step 130 is referred to as a modified second sub-image 32_{2M} (see FIG. 4).

With reference to FIGS. 3 and 4, in a step 134, a final image 32_{F} (see FIG. 4) is generated based on the modified first and second sub-images 32_{1M}, 32_{2M}. In one embodiment, the final image 32_{F} is generated by combining the first modified sub-image 32_{1M} and the second modified sub-image 32_{2M} into a single, bird's eye view image around the vehicle 10. It is contemplated that the final image 32_{F} is includes a top view of the vehicle 10. For example, each of the pixels in the first modified sub-image 32_{1M} is compared with a respective pixel in the second modified sub-image 32_{1M}. If the numerical color (or gray-scale) value of a pixel in the first modified sub-image 32_{1M} substantially matches the numerical color (or gray-scale) value of the corresponding pixel in the second modified sub-image 32_{2M}, the numerical color (or gray-scale) value of the pixel in the first modified sub-image 32_{1M} is used at the corresponding location of the final image 32_{F}. If, on the other hand, the numerical color (or gray-scale) value of a pixel in the first modified sub-image 32_{1M} does not substantially match the numerical color (or gray-scale) value of the corresponding pixel in the second modified sub-image 32_{2M}, an average of the numerical color (or gray-scale) values of the pixel in the first modified sub-image 32_{1M} and the corresponding pixel in the second modified sub-image 32_{2M} is used at the corresponding location of the final image 32_{F}.

In a step 136, an intersection point 40 between the modified first sub-image 32_{1M} and the modified second sub-image 32_{2M} that is a minimum distance to the first and second image capturing devices 12₁, 12₂, respectively, is identified. In one embodiment, the minimum distance from the intersection point 40 to the first and second image capturing devices 12₁, 12₂, respectively, is identified by determining, for each point at which the modified first sub-image 32_{1M} and the modified second sub-image 32_{2M} intersect, a total distance that is determined as a total of the respective distances to the first image capturing device 12₁ and the second image capturing device 12₂. The intersection point 40 having the smallest total distance is identified in the step 136 as minimum distance to the first and second image capturing devices 12022, respectively.

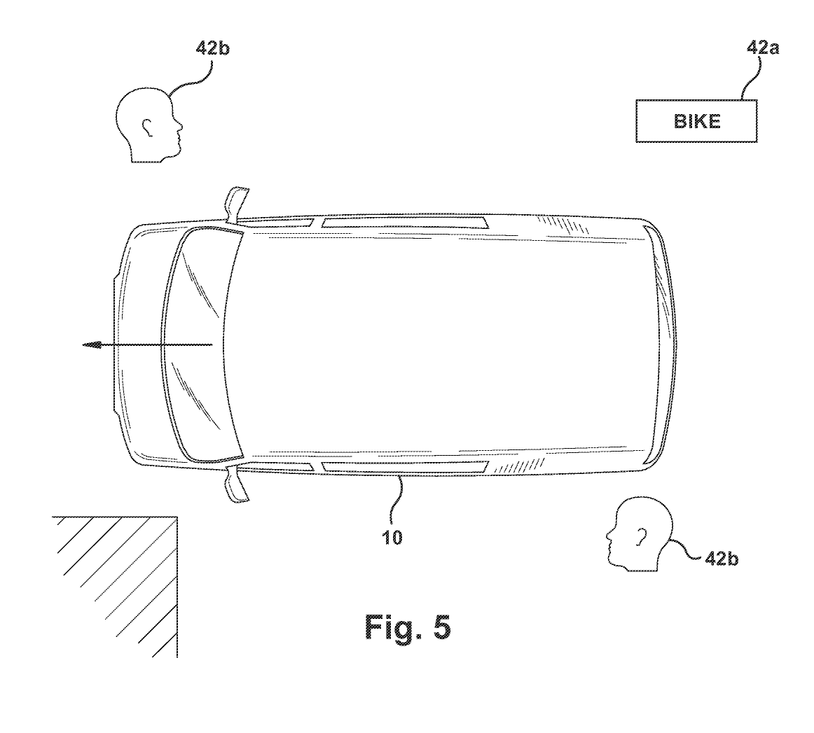

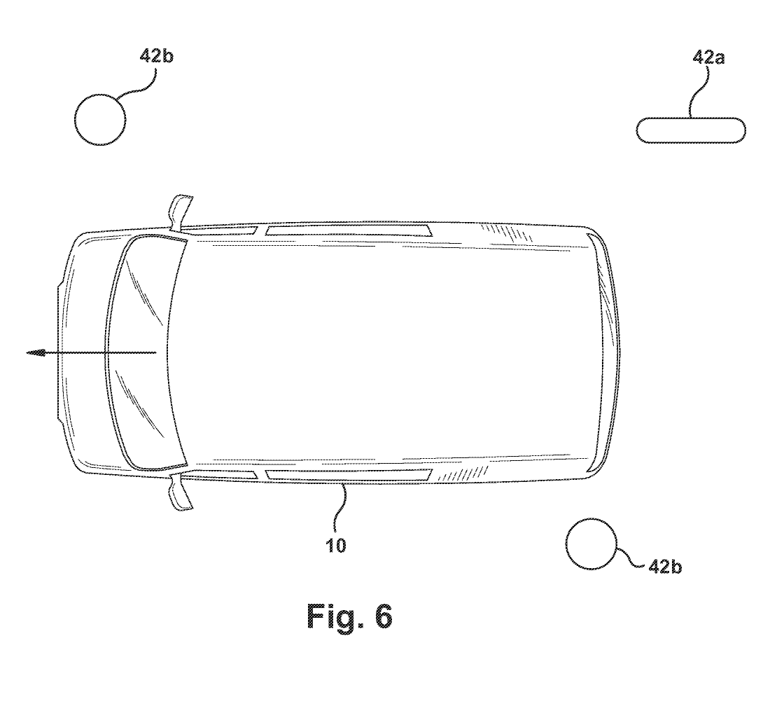

A base of the object 28 is identified at the intersection point 40 in a step 140. For example, an icon 42 (e.g., a triangle or circle) is placed in the final image 32_{F} to represent the location of the base of the object 28. With reference to FIG. 5, different examples of the icon 42 are illustrated. For example, it is contemplated that the icon 42 may be a box or shape 42a (e.g., a text box) including identifying information. For example, the box 42a may include text such as “BIKE” identifying the object as a bicycle or simply text such as “OBJECT” to generically identify the location of the object. It is also contemplated that the icon 42 may be a two-dimensional side-view (e.g., a person's profile 42b) or silhouette of the object. The silhouette may be derived from the wider, live, view of the object 28 as seen by one of the cameras 12₁, 12₂ for at least a predetermined time. With reference to FIG. 6, it is also contemplated that the icon 42 are may simply be a oblong shape 42a to represent a bicycle and a circle 42b to represent a person.

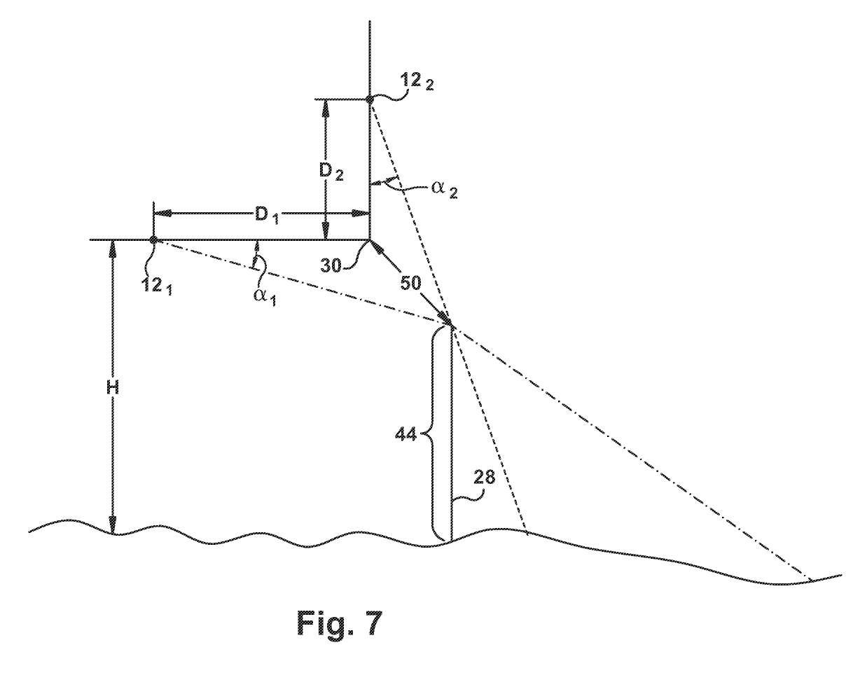

With reference to FIGS. 3-7, a height 44 of the object 28 is determined in a step 142. Since respective heights of the image capturing devices 12₁, 12₂, respectively, along with the base of the object 28 (e.g., the intersection point 40) and top of the object 28 (e.g., from the final image 32_{F}) are known, it is contemplated that the height 44 of the object 28 is determined according to standard trigonometric calculations. For example, the angles α₁, α₂, a distance D₁ of the first image capturing device 12₁ from the left, rear corner 30 of the vehicle 10, a distance D₂ of the second image capturing device 12₂ from the left, rear corner 30 of the vehicle 10, and a height H of the first and second image capturing devices 12_{1,2} are used to determine the height 44 of the object 28.

The height 44 of the object 28 is conveyed in the final image 32_{F} in a step 144. In one embodiment, the height 44 of the object 28 may be conveyed by displaying the icon 42 in a particular color. For example, a red icon 42 may be used to identify an object 28 over 7 feet high (tall), a yellow icon 42 may be used to identify an object 28 between 4 feet and 7 feet high (tall), and a green icon 42 may be used to identify an object 28 less than 4 feet high (tall). Alternatively, or in addition to the colored icon 42, a number 46 may be displayed proximate the icon 42 indicating the height 44 of the object 28 in, for example, feet and/or a size of the icon 42 displayed in the final image 32_{F} in may be based on the height 44 of the object 28 (e.g., an object less than 4 feet tall is represented by a relatively smaller icon 42 than an object greater than 4 feet tall, and an object less than 6 feet tall is represented by a relatively smaller icon 42 than an object greater than 6 feet tall).

The distance 50 between the base of the object 28 and the vehicle 10 is determined in the final image 32_{F} in a step 146. In one embodiment, the distance 50 is determined to be the shortest distance between the base of the object 28 and the vehicle 10. It is to be understood that trigonometry is used by the ECU 22 to determine the shortest distance between the object 28 and the vehicle 10. The distance is conveyed in a step 150. The distance 50 may be conveyed by displaying the icon 42 in a particular color. For example, a red icon 42 may be used to identify an object 28 is less than 3 feet to the vehicle 10, a yellow icon 42 may be used to identify an object 28 that is between 3 feet and 6 feet to the vehicle 10, and a green icon 42 may be used to identify an object 28 more than 6 feet to the vehicle 10. The color of the object 28 may change as the distance between the object 28 and the vehicle 10 changes. For example, if the object 28 is initially more than 6 feet from the vehicle 10 but then quickly comes within 3 feet of the vehicle 10, the color of the object 28 would initially be green and then change to red. Optionally, an operator of the vehicle is notified if the object 28 is less than 6 feet from the vehicle 10. In addition, a time until the object 28 is expected to collide with the vehicle 10, based on a current rate of movement toward each other, could be indicated.

Alternatively, or in addition to the colored icon 42, a number 52 may be displayed proximate the icon 42 indicating the distance of the object 28 to the vehicle 10 in, for example, feet and/or a size of the icon 42 displayed in the final image 32_{F} may be based on the distance 50 of the object 28 to the vehicle 10 (e.g., an object less than 3 feet to the vehicle 10 is represented by a relatively smaller icon 42 than an object greater than 3 feet to the vehicle 10, and an object less than 6 feet to the vehicle 10 is represented by a relatively smaller icon 42 than an object greater than 6 feet to the vehicle 10).

It is to be understood that different representations are used for conveying the height 44 of the object 28 and the distance 50 of the object 28 to the vehicle 10. For example, if color is used to convey the height 44 of the object 28, then some other representation (e.g., a size of the icon 42) is used to convey the distance 50 of the object 28 to the vehicle 10.

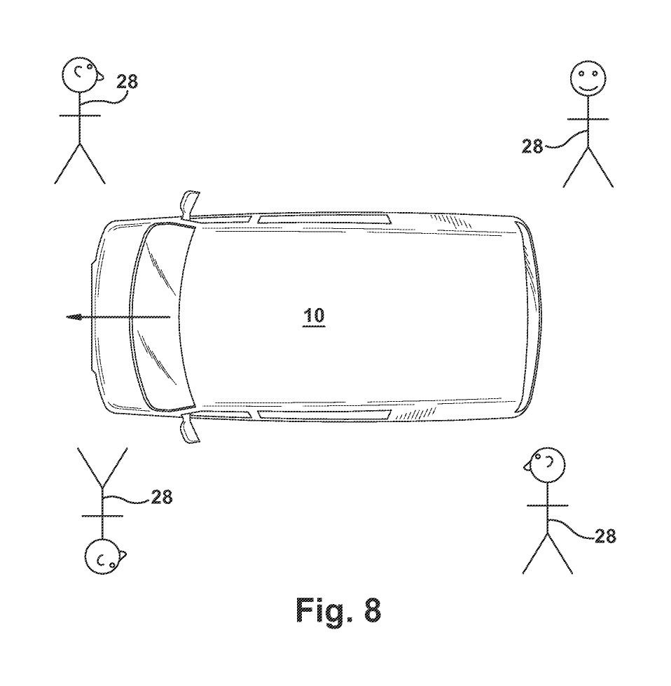

In one embodiment, it is contemplated that the object 28 and the vehicle 10 in the final image 32_{F} are not aligned with a common virtual viewpoint. In other words, simple two-dimensional views of any of the objects 28 and the vehicle 10 are presented in the final image 32_{F} without perspective on the display 24 (see FIG. 2). FIG. 8 illustrates the simple two-dimensional views of the vehicle 10 and of any of the objects 28 not aligned with a common virtual viewpoint. The orientation (e.g., right-side up or upside down) and facing direction (e.g., sideways or forward facing) of the objects 28 in the two-dimensional views on the display 24 (see FIG. 2) may be chosen by the driver. Since the objects 28 in the two-dimensional views are not aligned with a common virtual viewpoint, vertical objects do not radiate diagonally outward. Instead, the objects 28 are simply illustrated as two-dimensional icons.

It is contemplated that the final image 32_{F} is continuously generated from the first and second sub-images 32_{1M}, 32_{2M} and the first and second sub-images 32_{1M}, 32_{2M} are continuously generated from the first and second images 32₁, 32₂. Therefore, the final image 32_{F} is continuously displayed in real-time (e.g., live) on the display device 24 (see FIG. 2). In this sense, none of the first and second images 32₁, 32₂, the first and second sub-images 32₁, 32₂, or the final image 32_{F} is electronically stored—it is simply displayed continuously in real-time, with no intervening pause.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A method for graphically indicating an object in a final image, the method comprising:
obtaining a plurality of sub-images including the object from respective image capturing devices at different angles;
replacing a portion of a first of the sub-images with a corresponding portion of a second of the sub-images;
replacing a portion of the second sub-image with a corresponding portion of the first sub-image; and
generating the final image including a graphical representation of the object as a two-dimensional view not aligned with a common virtual viewpoint based on the first and second sub-images including the respective replaced portions.

2. The method for graphically indicating an object in a final image as set forth in claim 1, further including:
identifying the portion of the first sub-image to be replaced as inconsistent with the corresponding portion of the second sub-image; and
identifying the portion of the second sub-image to be replaced as inconsistent with the corresponding portion of the first sub-image.

3. The method for graphically indicating an object in a final image as set forth in claim 2, wherein:
the step of identifying the portion of the first sub-image to be replaced as inconsistent with the corresponding portion of the second sub-image includes:
identifying a pixel in the first sub-image that does not substantially match a corresponding pixel in the second sub-image; and
the step of identifying the portion of the second sub-image to be replaced as inconsistent with the corresponding portion of the first sub-image includes:
identifying a pixel in the second sub-image that does not substantially match a corresponding pixel in the first sub-image.

4. The method for graphically indicating an object in a final image as set forth in claim 1, further including:
identifying an intersection point of the first sub-image and the second sub-image that is a minimum distance to the respective first and second image capturing devices.

5. The method for graphically indicating an object in a final image as set forth in claim 4, further including:
identifying a location of a base of the object at the intersection point.

6. The method for graphically indicating at object in a final image as set forth in claim 1, wherein the generating step includes:
determining a height of the object via a trigonometric estimation.

7. The method for graphically indicating an object in a final image as set forth in claim 1, further including:
conveying a height of the object in the final image.

8. The method for graphically indicating an object in a final image as set forth in claim 7, wherein the conveying step includes:
conveying the height of the object in the final image.

9. The method for graphically indicating an object in a final image as set forth in claim 8, wherein the step of conveying the height of the object in the final image includes:
displaying a size of the graphical representation of the object based on the height of the object.

10. A controller for generating a signal to graphically indicate an object in a final mage, the controller comprising:
means for obtaining a plurality of sub-images including the object from respective image capturing devices at different angles;
means for replacing a portion of a first of the sub-images with a corresponding portion of a second of the sub-images;
means for replacing a portion of the second sub-image with a corresponding portion of the first sub-image; and
means for generating the final image including a graphical representation of the object as a two-dimensional view not aligned with a common virtual viewpoint based on the first and second sub-images including the respective replaced portions.

11. The controller as set forth in claim 10, further including:
means for identifying the portion of the first sub-image to be replaced as inconsistent with the corresponding portion of the second sub-image; and
means for identifying the portion of the second sub-image to be replaced as inconsistent with the corresponding portion of the first sub-image.

12. The controller as set forth in claim 10, further including:
means for identifying a location of a base of the object at the intersection point.

13. The controller as set forth in claim 10, further including:
means for determining a height of the object.

14. The controller as set forth in claim 13, further including:
means for displaying the height of the object.

15. The controller as set forth in claim 10, further including:
means for determining a distance of the object to an associated vehicle.

16. The controller as set forth in claim 15, further including:
means for displaying the distance of the object to the associated vehicle.

17. A system for graphically indicating an object in a final image, the system comprising:
a plurality of image capturing devices obtaining respective sub-images including the object, each of the sub-images being captured at a different angle;
a controller for replacing a portion of a first of the sub-images with a corresponding portion of a second of the sub-images, replacing a portion of the second sub-image with a corresponding portion of the first sub-image, and generating the final image including a graphical representation of the object as a two-dimensional view not aligned with a common virtual viewpoint based on the first and second sub-images including the respective replaced portions.

18. The system for graphically indicating an object in a final image as set forth in claim 17, further including:
a display for displaying the final image.

19. The system for graphically indicating an object in a final image as set forth in claim 17, wherein:
the controller identifies the portion of the first sub-image to be replaced as inconsistent with the corresponding portion of the second sub-image; and
the controller identifies the portion of the second sub-image to be replaced as inconsistent with the corresponding portion of the first sub-image.

20. The system for graphically indicating an object in a final image as set forth in claim 19, wherein:
the controller identifies a pixel in the first sub-image that does not substantially match a corresponding pixel in the second sub-image; and
the controller identifies a pixel in the second sub-image that does not substantially match a corresponding pixel in the first sub-image.

21. The system for graphically indicating an object in a final image as set forth in claim 17, wherein:
the controller identifies an intersection point of the first sub-image and the second sub-image that is a minimum distance to the respective first and second image capturing devices.

22. The system for graphically indicating an object in a final image as set forth in claim 21, wherein:
the controller identifies a location of a base of the object at the intersection point.

23. The system for graphically indicating an object in a final image as set forth in claim 17, wherein:
the controller determines a height of the object and generates a control signal for producing an icon conveying the height on an associated display.

24. The system for graphically indicating an object in a final image as set forth in claim 17, wherein:
the controller determines a distance of the object from an associated vehicle and generates a control signal for producing an icon conveying the distance on an associated display.

25. A controller for generating a signal to graphically indicate an object in a final image, the controller comprising an electronic control unit for:
receiving a plurality of sub-images including the object from respective image capturing devices at different angles;
replacing a portion of a first of the sub-images with a corresponding portion of a second of the sub-images;
replacing a portion of the second sub-image with a corresponding portion of the first sub-image;
generating signals representing the final image including a graphical representation of the object as a two-dimensional view not aligned with a common virtual viewpoint based on the first and second sub-images including the respective replaced portions; and
transmitting the signals representing the final image to an associated display.

26. A method for indicating an object in a display associated with a multiple view camera system, the method including:
obtaining a plurality of sub-images including the object from respective image capturing devices at different angles;
removing a portion of the object from a first of the sub-images;
removing a portion of the object from a second of the sub-images;
replacing the removed portions of the object with a single, graphical representation of the object; and
displaying a graphical representation of the object as a two-dimensional view not aligned with a common virtual viewpoint based on the first and second sub-images including the respective replaced portions.

27. The method for indicating an object in a display associated with a multiple view camera system as set forth in claim 26, wherein the replacing step includes:
replacing the removed portions of the object with a text representation of the object.

28. The method for indicating an object in a display associated with a multiple view camera system as set forth in claim 26, wherein the replacing step includes:
replacing the removed portions of the object with a widest of the views of the object from each of the sub-images.

29. The method for indicating an object in a display associated with a multiple view camera system as set forth in claim 28, further including:
identifying the widest of the views as the view having a widest image of the object for at least a predetermined time.

30. The method for indicating an object in a display associated with a multiple view camera system as set forth in claim 26, wherein the replacing step includes:
replacing the removed portions of the object with a silhouette of the object.
